(19) United States
(12) Patent Application Publication
(10) Pub. No.: US 2026/0310745 A1
(43) Pub. Date: Oct. 8, 2026

(54) INFORMATION PROCESSING APPARATUS

(71) Applicant: NEC Corporation, Tokyo (JP)

(72) Inventor: Motoi SUZUKI, Tokyo (JP)

(73) Assignee: NEC Corporation, Tokyo (JP)

(21) Appl. No.: 19/457,572

(22) Filed: Jan. 23, 2026

(30) Foreign Application Priority Data
Feb. 6, 2025 (JP) 2025-018701

(51) Int. Cl. G06F 17/11

(52) U.S. Cl. CPC G06F 17/11

(57) ABSTRACT

An information processing apparatus of the present disclosure includes a search unit that transitions, when a solution of a variable of a constrained combinatorial optimization problem is searched for by a plurality of processes to which pieces of the optimization problem obtained by dividing the optimization problem are allocated, the variable while maintaining a constraint of the variable of the optimization problem, the constraint extending over a plurality of the processes, and performs the search, and a control unit that performs control to allow transition of the variable that breaks the constraint under a preset condition. Therefore, the proposed information processing apparatus accelerates decision making by leveraging artificial intelligence (AI) techniques during the optimization search.

### INCORPORATION OF BASIC APPLICATION

The present invention is based upon and claims the benefit of the priority of Japanese Patent Application No. 2025-018701 filed on Feb. 6, 2025 in Japan, the disclosure of which is incorporated herein in its entirety by reference.

### TECHNICAL FIELD

The present disclosure relates to an information processing apparatus.

### BACKGROUND ART

As a method for solving a problem in a real world, energy (Hamiltonian) in a combinatorial optimization problem is converted into a form of a formulated Ising model, and the combinatorial optimization problem is solved. As an example, energy of an optimization problem is formulated in a quadratic unconstrained binary optimization (QUBO) form, and the optimization problem is solved by simulated annealing.

On the other hand, when a problem scale of the optimization problem increases, it takes time to perform solving processing. In order to cope with the large-scale optimization problem, PTL 1 describes that an optimization problem is solved by being distributed to a plurality of processes.
PTL 1: WO 2023/047463 A1

### SUMMARY

However, when the optimization problem is solved by being distributed to the plurality of processes, it is necessary to perform communication between the processes. For example, it is necessary to communicate between the processes and confirm whether a constraint of the optimization problem is satisfied. As a result, there arises a problem that it takes time to solve the optimization problem due to the communication between the processes.

Therefore, an object of the present disclosure is to solve the above-described problem that it takes time to solve an optimization problem.

An information processing apparatus that is one aspect of the present disclosure adopts a configuration including
a search unit that transitions, when a solution of a variable of a constrained combinatorial optimization problem is searched for by a plurality of processes to which pieces of the optimization problem obtained by dividing the optimization problem are allocated, the variable while maintaining a constraint of the variable of the optimization problem, the constraint extending over a plurality of the processes, and performs the search, and
a control unit that performs control to allow transition of the variable that breaks the constraint under a preset condition.

An information processing method that is one aspect of the present disclosure adopts a configuration including,
by an information processing apparatus,
transitioning, when a solution of a variable of a constrained combinatorial optimization problem is searched for by a plurality of processes to which pieces of the optimization problem obtained by dividing the optimization problem are allocated, the variable in such a way as to maintain a constraint of the optimization problem, the constraint extending over a plurality of the processes, and performing the search, and performing control to allow transition of the variable that breaks the constraint under a preset condition.

A program that is one aspect of the present disclosure adopts a configuration including
causing an information processing apparatus to execute processing of
transitioning, when a solution of a variable of a constrained combinatorial optimization problem is searched for by a plurality of processes to which pieces of the optimization problem obtained by dividing the optimization problem are allocated, the variable in such a way as to maintain a constraint of the optimization problem, the constraint extending over a plurality of the processes, and performing the search, and performing control to allow transition of the variable that breaks the constraint under a preset condition.

With the above configuration, the present disclosure can shorten a time taken to solve an optimization problem.

### BRIEF DESCRIPTION OF THE DRAWINGS

FIG. 1 is a block diagram illustrating an example of a configuration of an information processing system according to the present disclosure;

FIG. 2 is a block diagram illustrating an example of the configuration of the information processing system according to the present disclosure;

FIG. 3 is a flowchart illustrating an example of processing operation by the information processing system according to the present disclosure;

FIG. 4 is a diagram illustrating an example of data related to the present disclosure;

FIG. 5 is a diagram illustrating an example of the data related to the present disclosure;

FIG. 6 is a diagram illustrating an example of the data related to the present disclosure;

FIG. 7 is a diagram illustrating an example of the data related to the present disclosure;

FIG. 8 is a diagram illustrating an example of the data related to the present disclosure;

FIG. 9 is a diagram illustrating an example of the data related to the present disclosure;

FIG. 10 is a diagram illustrating an example of the data related to the present disclosure;

FIG. 11 is a block diagram illustrating an example of a configuration of an information processing system according to the present disclosure;

FIG. 12 is a flowchart illustrating an example of processing operation by the information processing system according to the present disclosure;

FIG. 13 is a diagram illustrating an example of data related to the present disclosure;

FIG. 14 is a diagram illustrating an example of the data related to the present disclosure;

FIG. 15 is a diagram illustrating an example of the data related to the present disclosure;

FIG. 16 is a block diagram illustrating an example of a hardware configuration of an information processing apparatus according to the present disclosure;

FIG. 17 is a block diagram illustrating an example of a configuration of the information processing apparatus according to the present disclosure;

FIG. 18 is a block diagram illustrating an example of the configuration of the information processing apparatus according to the present disclosure;

FIG. 19 is a flowchart illustrating an example of processing operation by the information processing apparatus according to the present disclosure; and

FIG. 20 is a flowchart illustrating an example of the processing operation by the information processing apparatus according to the present disclosure.

### EXAMPLE EMBODIMENT

### First Example Embodiment

A first example embodiment of the present disclosure will be described with reference to the drawings. The drawings may relate to any example embodiment.

As an example, an information processing system of the present disclosure is used to solve a preset constrained combinatorial optimization problem. In particular, in the present example embodiment, an example in which the constrained combinatorial optimization problem is converted into a quadratic unconstrained binary optimization (QUBO) model that is a formulated model and solved will be described. However, the information processing system of the present disclosure is not necessarily limited to converting the optimization problem into the QUBO model and solving the optimization problem, and can also be applied to converting the optimization problem into any form of model such as an Ising model and solving the optimization problem.

Specifically, the constrained combinatorial optimization problem is a problem in which an objective function and a constraint condition are set, and a solution that minimizes the objective function while satisfying the constraint condition is obtained. The constrained combinatorial optimization problem can be converted into the QUBO model as indicated in Expression 1 and Expression 2. At this time, the constrained combinatorial optimization problem can represent an energy value of the optimization problem, that is, a Hamiltonian H, by using an objective function term (a first term and a second term) and a constraint condition term (a third term and a fourth term) as indicated in Expression 1, and these can be combined into the one model as indicated in Expression 2.

$$H = {\sum }_{i} {\sum }_{j} {J}_{ij}^{′} {x}_{i} {x}_{j} + {\sum }_{i} {h}_{i}^{′} {x}_{i} + {\sum }_{i} {\sum }_{j} {\hat{J}}_{ij} {x}_{i} {x}_{j} + {\sum }_{i} {\hat{h}}_{i}^{′} {x}_{i} \qquad [ Expression 1 ]$$

$$H = {\sum }_{i} {\sum }_{j} {J}_{ij} {x}_{i} {x}_{j} + {\sum }_{i} {h}_{i} {x}_{i} + {\sum }_{i} {\sum }_{j} {Q}_{ij} {x}_{i} {x}_{j} \qquad [ Expression 2 ]$$

In the above-described expressions, xᵢ and xⱼ are variables representing states of spins xᵢ and xⱼ, and are expressed by “0” or “1”. Identification numbers of the spins x are indicated by i and j. In the above-described Expression 2, Qᵢⱼ is a weight parameter set related to each combination of the spins xᵢ and xⱼ, and is referred to as a QUBO matrix.

In the above-described constrained combinatorial optimization problem, an optimal solution can be obtained by solving a spin with a minimum Hamiltonian H by a technique referred to as simulated annealing (pseudo quantum annealing). At this time, by flipping the state of the spin x from 0 to 1 or from 1 to 0, the solution is transitioned and searched for. In the simulated annealing, at the time of searching for the solution, transition is always made in a case where an evaluation value of a neighborhood solution is good (small), but transition can be made stochastically even in a case where the evaluation value of the neighborhood solution is poor (large). Since a probability at this time is determined by an inverse temperature that is a reciprocal of a value of a temperature parameter, the solution is searched for while increasing or decreasing the inverse temperature.

An example of the constrained combinatorial optimization problem is referred to as a traveling salesman problem. The traveling salesman problem is an optimization problem in which, when distances between cities are given, a traveling route having a minimum movement distance is obtained under a constraint condition that a salesman visits every city once. In this manner, in the traveling salesman problem, a “One-hot” constraint, which is a constraint that only one of included variables x is 1, is set as the constraint condition. Therefore, in the constrained combinatorial optimization problem, basically, the solution is searched for while maintaining the constraint. The constrained combinatorial optimization problem targeted in the present disclosure is not limited to the above-described traveling salesman problem, and may be any problem. The constraint is not limited to the above-described “One-hot” constraint, and may be a constraint of any content.

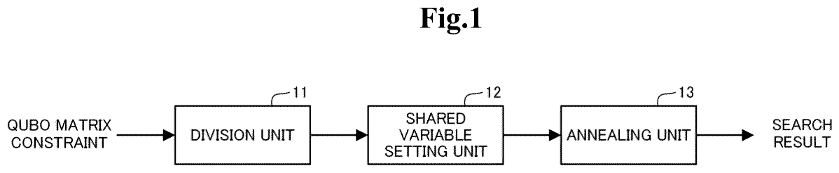

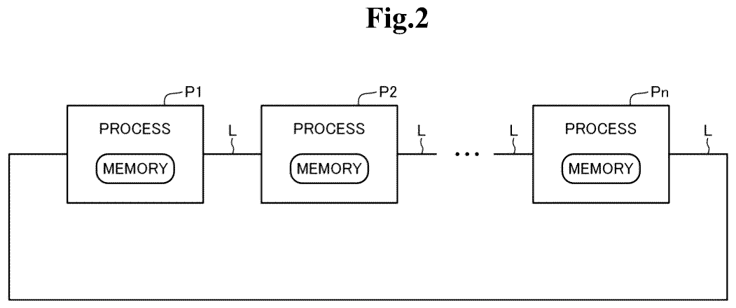

Next, an example of a configuration of the information processing system in the present example embodiment will be described in detail. FIG. 1 illustrates an example of the configuration of the information processing system, and FIG. 2 illustrates an example of operation of the information processing system. The information processing system includes one or a plurality of information processing apparatuses including an arithmetic device and a storage device. As illustrated in FIG. 1, the information processing system includes a division unit 11, a shared variable setting unit 12, and an annealing unit 13. Each of functions of the division unit 11, the shared variable setting unit 12, and the annealing unit 13 can be achieved by the arithmetic device executing a program for achieving each function stored in the storage device. Hereinafter, each configuration will be described.

The division unit 11 first receives input of a model obtained by converting a constrained combinatorial optimization problem. At this time, the division unit 11 receives input of, for example, a QUBO matrix constituting a QUBO model obtained by converting the optimization problem and the “One-hot” constraint as a constraint. The division unit 11 then divides the QUBO matrix and a variable into a plurality of pieces, and allocates each of the plurality of pieces to a plurality of processes P1 to Pn. That is, when a problem scale of the optimization problem increases, it takes time to perform solving processing, and thus the division unit 11 divides the optimization problem in such a way that solution search is executed in a distributed manner.

The plurality of processes P1 to Pn are configured by the annealing unit 13 (search unit). Each of the plurality of processes P1 to Pn is a solving device referred to as an annealer, and as illustrated in FIG. 2, each of the plurality of processes P1 to Pn includes a physical or virtual information processing apparatus, and is connected via a communication path L. Each of the processes P1 to Pn includes a memory, and searches for a solution by simulated annealing for the divided and allocated QUBO matrix and variable. For example, each of the processes P1 to Pn calculates the Hamiltonian H for the allocated QUBO matrix and variable, and searches for a solution with the minimum Hamiltonian H in the entire problem.

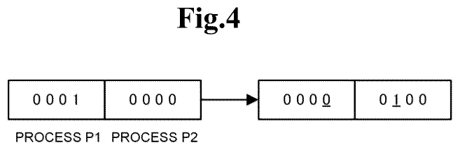

Here, the processing of searching for a solution by the plurality of processes P1 to Pn will be described. FIG. 4 illustrates an example in which a solution is searched for in a distributed manner in two processes such as the process P1 and the process P2 connected adjacent to each other via the communication path L. At this time, it is assumed that four spins, that is, variables are allocated to each of the process P1 and the process P2, and the “One-hot” constraint is given to the total of eight variables. That is, it is assumed that the “One-hot” constraint extends over the plurality of processes. At the time of searching for a solution, flipping that is performed across the processes is also conceivable such as from a state where a spin “1” is present in the process P1 as illustrated in the left diagram of FIG. 4 to a state where the spin “1” is present in the process P2 as illustrated in the right diagram of FIG. 4. However, in order to perform such flipping, it is necessary for the process P1 and the process P2 to communicate with each other due to the above-described “One-hot” constraint. Since there is a problem that a time cost for the communication is large, the following configuration is adopted in the present disclosure.

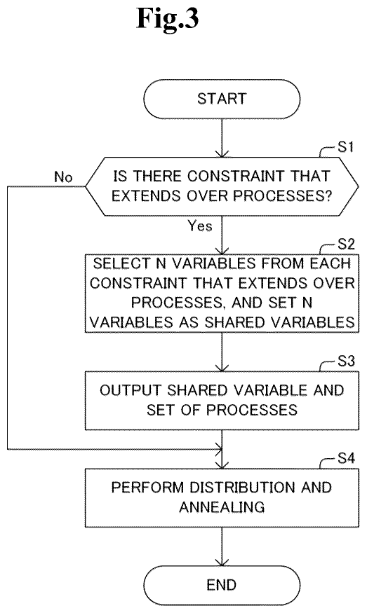

The shared variable setting unit 12 (setting unit) sets a spin, that is, a variable to be shared by the plurality of processes, that is, the process P1 and the process P2 connected adjacent to each other in the example of FIG. 4. Specifically, the shared variable setting unit 12 checks whether there is a constraint that extends over the processes P1 and P2 based on the variables and constraints allocated to the processes P1 and P2 (step S1 in FIG. 3). In a case where there is the constraint that extends over the processes P1 and P2 (Yes in step S1 in FIG. 3), N variables shared by the processes P1 and P2 are set (step S2 in FIG. 3).

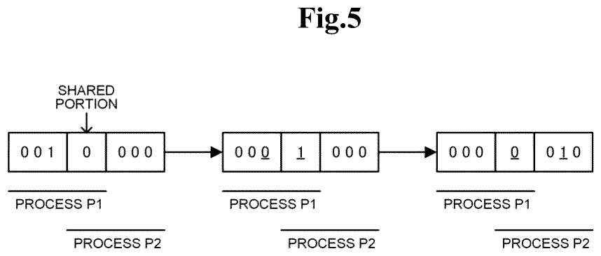

As an example, since the “One-hot” constraint is set between the processes P1 and P2, as illustrated in FIG. 5, a shared portion is set in the memory in the process P1 and the memory in the process P2, and one shared variable is set in the shared portion. A portion other than the shared portion in each of the process P1 and the process P2 is an exclusive portion of each process. At this time, the shared variable setting unit 12 may output the set shared variable and a set of the processes that share the shared variable (step S3 in FIG. 3). Based on the output information, as described above, the optimization problem is distributed to the processes P1 to Pn included in the annealing unit 13, and a solution is searched for by the processes P1 to Pn by the simulated annealing (step S4 in FIG. 3).

In this manner, by searching for the solution in the state where the variable is shared between the processes P1 and P2, from a situation where the spin “1” is present in the exclusive portion in the process P1 as illustrated in the left side of FIG. 5, the spin “1” is flipped to the shared portion of both the processes P1 and P2 as illustrated in the center of FIG. 5, and then the spin “1” is flipped to the exclusive portion in the process P2 and transition is made as illustrated in the right side of FIG. 5. In this manner, by causing the spin “1” to jump from the process P1 to the process P2 via the shared portion between the processes P1 and P2, it is necessary to perform the communication between the processes P1 and P2 when the spin “1” is flipped to the shared portion, but it is not necessary to perform the communication between the processes P1 and P2 each time of flipping before and after the jump. As a result, a solution search time can be shortened.

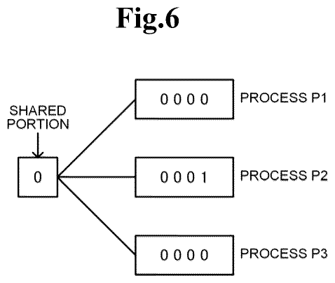

The shared variable setting unit 12 is not limited to setting the shared variable between the processes connected adjacent to each other, and may set the shared variable to all the processes connected to each other. For example, in the example of FIG. 6, it is assumed that the “One-hot” constraint is set in the connected processes P1, P2, and P3, and in this case, a shared portion related to all the processes P1, P2, and P3 may be provided and a shared variable may be set. That is, in the example of FIG. 6, the memories in the processes P1, P2, and P3 include the shared portion in which the shared variable is set. Even in such a configuration, by causing the spin “1” to jump among the processes P1, P2, and P3 via the shared portion, it is necessary to perform communication among the processes P1, P2, and P3 when the spin “1” is flipped to the shared portion, but it is not necessary to perform the communication among the processes each time of flipping before and after the jump. As a result, a solution search time can be shortened. The shared portion may include the memories in the processes P1, P2, and P3, or may be set in a memory outside the processes P1, P2, and P3, and in that case, the variable of the shared portion is copied to the memories in the processes P1, P2, and P3.

Here, the shared variable setting unit 12 may set a size of the shared portion based on a memory size included in the process P. For example, as memory sizes of all the processes P to be set with the shared portion are larger, the shared portion may be set larger, and the number of shared variables may be set larger. That is, in the above description, the case where there is one shared variable has been exemplified, but a plurality of the shared variables may be set.

The shared variable setting unit 12 may also set the shared portion, that is, the shared variable according to a search situation of the solution of the variable by the process P. For example, the shared variable setting unit 12 may use a predetermined variable as the shared variable according to a flip rate of the spin at regular intervals at the time of searching for the solution. As an example, a variable having a higher flip rate to the spin “1” than the others may be set as the shared variable. As an example, a predetermined number of variables in descending order of a flip rate to the spin “1” may be set as the shared variables.

### Application Example

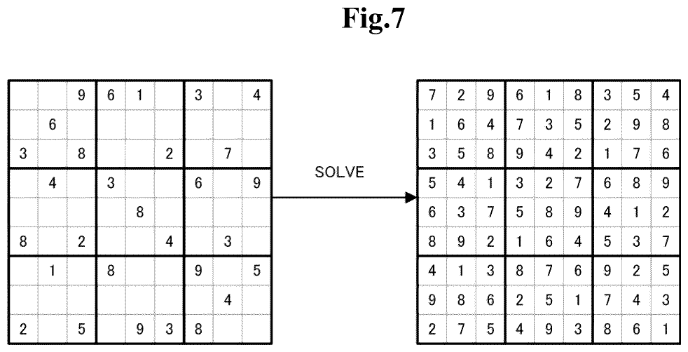

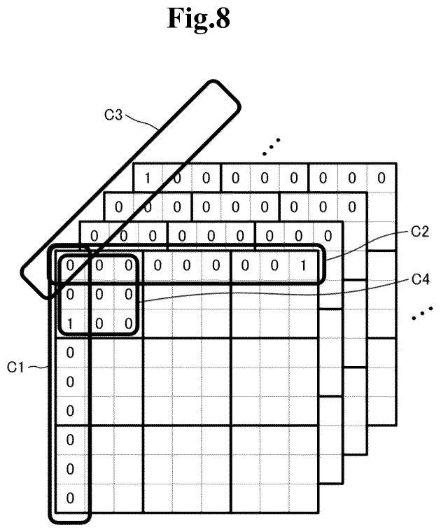

Next, another application example of the above-described information processing system will be described. Here, as an optimization problem for searching for a solution, a problem referred to as “Sudoku” will be described as an example. As illustrated in FIG. 7, Sudoku is a puzzle in which numbers 1 to 9 are arranged in vertical and horizontal rows with respect to 9×9 squares. At this time, there is a constraint that the numbers are arranged in such a way that they do not overlap each other in each of one vertical column, one horizontal column, and 3×3 squares. Therefore, Sudoku can be converted into a QUBO model, and as illustrated in FIG. 8, can be expressed by the “One-hot” constraint with columns and 3×3 squares indicated by reference signs C1 to C4 in a state where nine sheets each including 9×9 squares are arranged. The Hamiltonian H can be expressed as the following Expression 3.

$$H = {\sum }_{ij} {( 1 - {\sum }_{k} {x}_{ijk} )}^{2} + {\sum }_{jk} {( 1 - {\sum }_{i} {x}_{ijk} )}^{2} + {\sum }_{ki} {( 1 - {\sum }_{j} {x}_{ijk} )}^{2} + {\sum }_{kn} {( 1 - {\sum }_{〈 i , j 〉 ∈ {B}_{n}} {x}_{ijk} )}^{2} \qquad [ Expression 3 ]$$

$${x}_{ijk} , 1 \leq i , j , k \leq 9 :$$

A variable having a value of 1 in a case where there is a number k in an i-th row and a j-th row, and having a value of 0 in a case where there is no number k in the i-th row and the j-th row
Bₙ, 1≤n≤9:3×3 squares each indicated by a thick frame in FIG. 7

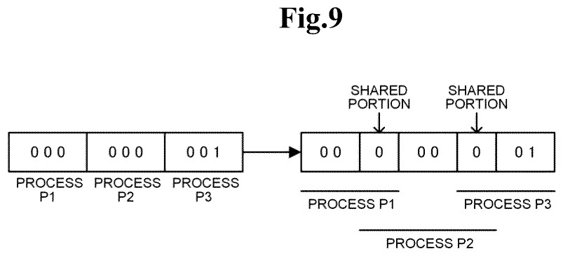

In the above-described Sudoku, a solution can be searched for by the simulated annealing as the optimization problem in which the “One-hot” constraint that extends over the processes P1, P2, and P3 is set as illustrated in the left diagram of FIG. 9. At this time, as illustrated in the right diagram of FIG. 9, shared portions are provided between the adjacent connected processes, that is, between the processes P1 and P2 and between the processes P2 and P3, and shared variables are set. As a result, by causing the spin “1” to jump via the shared portions between the processes P1 and P2 and between the processes P2 and P3, it is not necessary to perform communication between the processes P1 and P2 each time of flipping before and after the jump. As a result, a solution search time can be shortened.

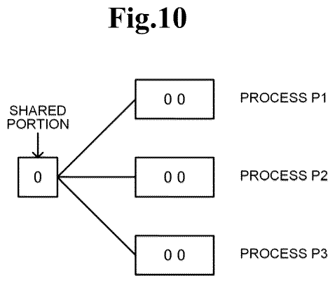

As another example, in the above-described Sudoku, a shared portion related to all the three processes P1, P2, and P3 may be provided and a shared variable may be set. That is, as illustrated in FIG. 10, each of the processes P1, P2, and P3 includes the shared portion. At this time, the shared portion may include the memories in the processes P1, P2, and P3, or may include a memory outside the processes P1, P2, and P3. Even in such a configuration, by causing the spin “1” to jump among the processes P1, P2, and P3 via the shared portion, it is not necessary to perform communication among the processes each time of flipping before and after the jump. As a result, a solution search time can be shortened.

### Second Example Embodiment

Next, a second example embodiment of the present disclosure will be described with reference to the drawings. The drawings may relate to any example embodiment.

An information processing system in the present example embodiment has a configuration partially similar to that of the above-described first example embodiment. In addition, the information processing system includes the following configuration. Hereinafter, the configuration different from that of the first example embodiment will be mainly described.

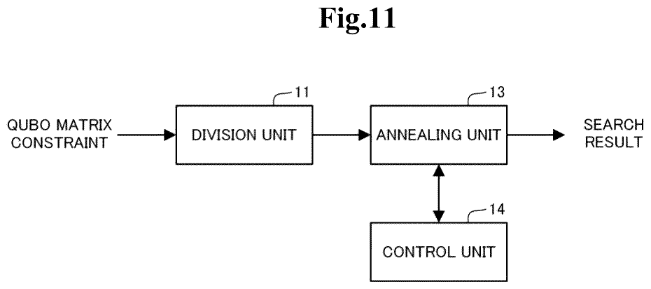

An example of the configuration of the information processing system in the present example embodiment will be described in detail. FIG. 11 illustrates an example of the configuration of the information processing system. The information processing system includes one or a plurality of information processing apparatuses including an arithmetic device and a storage device. As illustrated in FIG. 11, the information processing system includes a division unit 11, an annealing unit 13, and a control unit 14. Each of functions of the division unit 11, the annealing unit 13, and the control unit 14 can be achieved by the arithmetic device executing a program for achieving each function stored in the storage device. Hereinafter, each configuration will be described.

The division unit 11 has a configuration similar to that of the above-described first example embodiment, and receives input of a model obtained by converting a constrained combinatorial optimization problem. At this time, the division unit 11 receives input of, for example, a QUBO matrix constituting a QUBO model obtained by converting the optimization problem and a “One-hot” constraint as a constraint. The division unit 11 then divides the QUBO matrix and a variable, and allocates each of the QUBO matrix and the variable to a plurality of processes P1 to Pn.

The annealing unit 13 (search unit) has a configuration similar to that of the above-described first example embodiment, and includes the plurality of processes P1 to Pn as illustrated in FIG. 2. Each of the plurality of processes P1 to Pn is a solving device referred to as an annealer, and each of the plurality of processes P1 to Pn includes a physical or virtual information processing apparatus, and is connected via a communication path L. Each of the processes P1 to Pn includes a memory, and searches for a solution by simulated annealing for the divided and allocated QUBO matrix and variable.

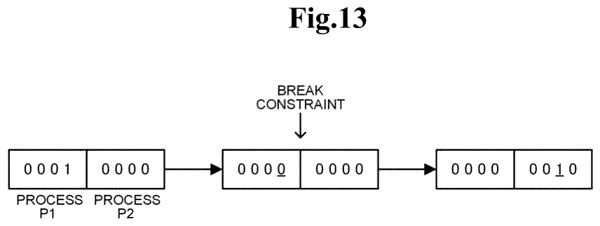

Here, also in the present example embodiment, similarly to the above description, it is assumed that the constraint of the optimization problem extends over the plurality of processes. For example, as illustrated in the left diagram of FIG. 13, it is assumed that the “One-hot” constraint is given to a total of eight variables allocated to the processes P1 and P2, and the constraint extends over the processes P1 and P2. At the time of searching for a solution, flipping that is performed across the processes is also conceivable such as from a state where a spin “1” is present in the process P1 as illustrated in the left diagram of FIG. 13 to a state where the spin “1” is present in the process P2 as illustrated in the right diagram of FIG. 13. However, in order to perform such flipping, it is necessary for the process P1 and the process P2 to communicate with each other due to the above-described “One-hot” constraint. Since there is a problem that a time cost for the communication is large, the following configuration is adopted in the present disclosure.

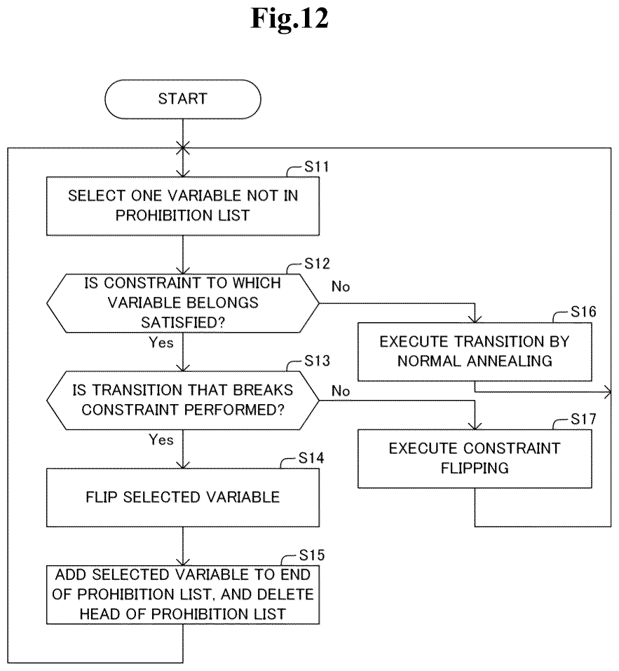

The information processing system in the present example embodiment includes the control unit 14 that controls the search for the solution by the above-described processes P. Normally, when searching for the solution in the plurality of processes P over which the constraint extends, the control unit 14 basically controls the processes P in such a way as to flip the variable while maintaining the constraint and search for the solution. Specifically, as an example of processing by the control unit 14, first, one variable is selected as an object to be flipped among the variables allocated to the processes P (step S11 in FIG. 12). At this time, the control unit 14 selects a variable not in a prohibition list to be described later. The control unit 14 checks whether the constraint to which the selected variable belongs is satisfied (step S12 in FIG. 12), and in a case where the constraint is not satisfied (No in step S12 in FIG. 12), performs control to search for the solution by normal simulated annealing in the processes P (step S16 in FIG. 12). In this case, since the constraint is not satisfied, it is assumed that no transition occurs due to the simulated annealing. In a case where the constraint to which the selected variable belongs is satisfied (Yes in step S12 in FIG. 12), and in the case of not a condition that breaks the constraint to be described later (No in step S13 in FIG. 12), the control unit 14 performs control to flip the variable in a state where the constraint is satisfied and search for the solution by the simulated annealing (step S17 in FIG. 12).

On the other hand, as described above, the control unit 14 controls the processes P to normally flip the variable while maintaining the constraint and search for the solution, and to allow the variable to be flipped by breaking the constraint under a predetermined condition. Specifically, as an example of the processing by the control unit 14, in a case where the constraint to which the selected variable belongs is satisfied (Yes in step S12 in FIG. 12), and in a case where the condition that breaks the constraint is satisfied (Yes in step S13 in FIG. 12), the selected variable is flipped to break the constraint (step S14 in FIG. 12). For example, as illustrated in the center of FIG. 13, the variable is flipped to break the “One-hot” constraint in the processes P1 and P2. As the condition that breaks the constraint, there is a preset condition based on a temperature parameter used for the simulated annealing, for example. Here, at the time of searching for the solution in the simulated annealing, a probability that the variable can flip or make transition in a case where evaluation of the solution is deteriorated is determined based on a set temperature parameter T. The variable is flipped to break the constraint with a probability p(T) indicated in Expression 4 based on the temperature parameter T.

$$p ( T ) = min ( 1 , {e}^{- KT} ) \qquad [ Expression 4 ]$$

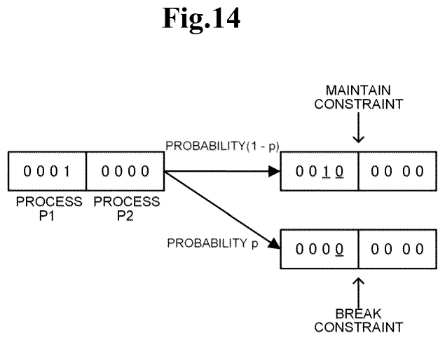

Therefore, at the time of searching for the solution, as illustrated in FIG. 14, the control unit 14 performs control in such a way that the variable is flipped to maintain the constraint with a probability (1−p(T)) and the search is performed, and performs control in such a way that the variable is flipped to break the constraint with the probability p(T). By setting a value of the temperature parameter T in such a way as to decrease as the search for the solution proceeds, that is, as a time of the search for the solution elapses, the probability of the flipping of the variable that breaks the constraint also decreases. Therefore, a frequency at which the flipping of the variable that breaks the constraint is performed increases at an initial stage of the search for the solution, and the frequency at which the flipping of the variable that breaks the constraint is performed decreases as the search for the solution proceeds.

As a result, for example, the state where the spin “1” is present in the process P1 as illustrated in the left diagram of FIG. 13 is changed to a state where the variable is flipped to break the constraint as illustrated in the center of FIG. 13. Thereafter, the spin “1” can be flipped into the process P2 as illustrated in the right diagram of FIG. 13 via the state where the constraint is broken. That is, the spin “1” is not jumped from the process P1 to the process P2, the communication between the processes P1 and P2 can be suppressed, and a solution search time can be shortened.

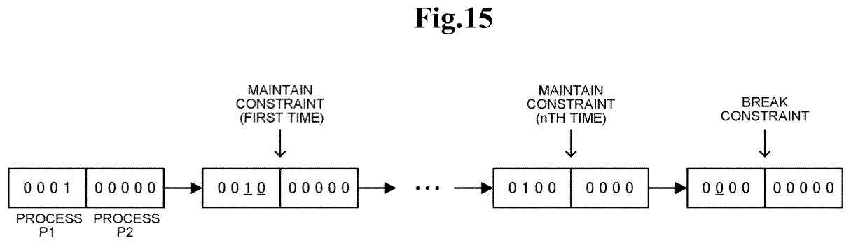

The control unit 14 may also perform control to flip the variable in such a way as to break the constraint under a condition based on the number of times of the transition of the variable. For example, control may be performed in such a way as to flip the variable to break the constraint every time the number of times n of flipping of the variable in the state where the constraint is maintained at the time of searching for the solution becomes a preset specified number of times. In the example of FIG. 15, the flipping of the variable that breaks the constraint is performed after the flipping of the variable that maintains the constraint is performed n times. The above-described number of times n may be any number of times, and is not limited to every certain number of times. For example, the above number of times n may be changed and set according to a situation of the search, such as a search time. As an example, the number of times n may be set to a small value in the initial stage of the search, and the number of times n may be set to a large value as the search proceeds.

After flipping the variable that breaks the constraint of the variable (step S14 in FIG. 12), the control unit 14 adds the flipped variable to an end of the prohibition list and deletes a head variable of the prohibition list (step S15 in FIG. 12). A predetermined number of variables can be registered in the prohibition list. As a result, in the predetermined number of times of subsequent search, the variable flipped to break the constraint is not selected (step S11 in FIG. 12), and the flipping of the variable is not performed. Therefore, the variable flipped to break the constraint is suppressed from returning to the original state.

The information processing system described in the present example embodiment can also be applied to the above-described problem referred to as “Sudoku” illustrated in FIGS. 7 and 8. In this case, as illustrated in FIGS. 14 and 15, at the time of searching for a solution, with respect to the constraint that extends over the plurality of processes P, normally the variable is flipped while maintaining the constraint and a solution is searched for, and flipping of the variable that breaks the constraint is performed when conditions such as a probability based on the temperature parameter and the number of times of the flipping that maintains the constraint are satisfied. As a result, in a case where the solution is searched for in a distributed manner by the plurality of processes, the communication between the processes P1 and P2 can be suppressed, and the solution search time can be shortened.

### Third Example Embodiment

Next, a third example embodiment of the present disclosure will be described. An information processing system in the present example embodiment has the configurations of the information processing systems in the above-described first and second example embodiments. That is, the information processing system in the present example embodiment includes the control unit 14 illustrated in FIG. 11 in addition to the division unit 11, the shared variable setting unit 12, and the annealing unit 13 illustrated in FIG. 1.

With the above configuration, in the information processing system in the present example embodiment, for example, the shared variable setting unit 12 sets a variable to be shared in some of a plurality of processes to which an optimization problem is distributed, similarly to the first example embodiment. The control unit 14 performs control to allow flipping of a variable that breaks a constraint under a predetermined condition in some of a plurality of other processes, similarly to the second example embodiment. In such a situation, the annealing unit 13 including a plurality of processes P searches for a solution.

In the information processing system in the present example embodiment, the shared variable setting unit 12 sets the variable to be shared in the plurality of processes to which the optimization problem is distributed, similarly to the first example embodiment. In addition, the control unit 14 performs control to allow the flipping of the variable that breaks the constraint under the predetermined condition in the plurality of processes in which the shared variable is set, similarly to the second example embodiment. In such a situation, the annealing unit 13 including the plurality of processes P searches for the solution.

As described above, even in a case where the configurations of the first and second example embodiments are combined, when the solution is searched for in a distributed manner by the plurality of processes, communication between the plurality of processes can be suppressed, and a solution search time can be shortened.

### Fourth Example Embodiment

Next, a fourth example embodiment of the present disclosure will be described with reference to the drawings. In the present example embodiment, an outline of the information processing apparatuses and the like described in the above-described example embodiments will be illustrated. The drawings may relate to any example embodiment.

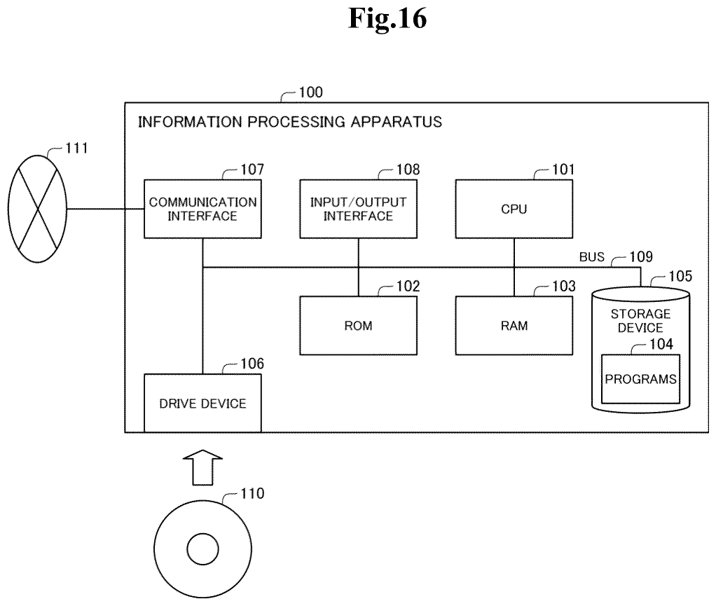

First, a hardware configuration of an information processing apparatus 100 in the present disclosure will be described. The information processing apparatus 100 is constituted by a general information processing apparatus, and is equipped with, as an example, the hardware configuration as follows, as illustrated in FIG. 16.
A central processing unit (CPU) 101 (arithmetic device)
A read only memory (ROM) 102 (storage device)
A random access memory (RAM) 103 (storage device)
Programs 104 to be loaded into the RAM 103
A storage device 105 that stores the programs 104
A drive device 106 that performs reading and writing on a storage medium 110 outside the information processing apparatus
A communication interface 107 connected to a communication network 111 outside the information processing apparatus
An input/output interface 108 that inputs and outputs data
A bus 109 that connects each component

FIG. 16 illustrates an example of the hardware configuration of the information processing apparatus that is the information processing apparatus 100, and the hardware configuration of the information processing apparatus is not limited to the above-described case. For example, the information processing apparatus may be constituted by a part of the above-described configuration such as not including the drive device 106. The information processing apparatus can use, instead of the above-described CPU, a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like.

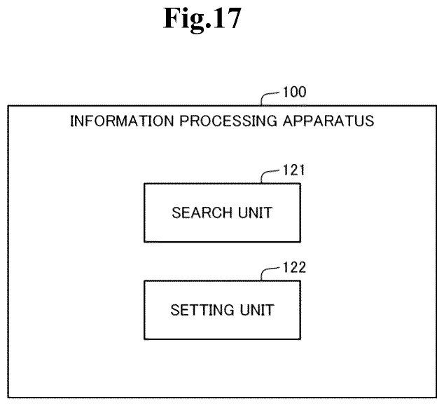

A search unit 121 and a setting unit 122 illustrated in FIG. 17 can be constructed and equipped in the information processing apparatus 100 by the CPU 101 acquiring and executing the programs 104. The programs 104 are stored in, for example, the storage device 105 or the ROM 102 in advance, and the CPU 101 loads and executes the programs 104 on the RAM 103, as necessary. The programs 104 may be supplied to the CPU 101 via the communication network 111, or the programs 104 may be stored in the storage medium 110 in advance and the drive device 106 may read the programs 104 and supply the read programs 104 to the CPU 101. However, the above-described search unit 121 and setting unit 122 may be constructed by a dedicated electronic circuit for achieving the means.

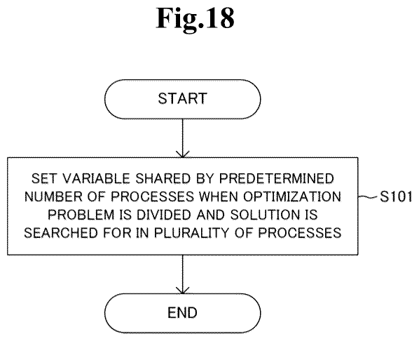

The above search unit 121 searches for a solution of a variable of a constrained combinatorial optimization problem by a plurality of processes to which pieces of the optimization problem obtained by dividing the optimization problem are allocated. The above setting unit 122 sets the variable shared by the plurality of processes at the time of search (step S101 in FIG. 18).

In the above configuration, the information processing apparatus 100 divides the constrained combinatorial optimization problem into the plurality of processes, allocates the divided optimization problems to the plurality of processes, and sets the variable shared by the plurality of processes. For example, a variable shared between a plurality of connected processes over which a constraint extends is set, or a variable shared between adjacent connected processes over which the constraint extends is set. The solution of the variable of the optimization problem is searched for by the plurality of processes in a state where the variable is shared by the plurality of processes. As a result, it is possible to cause a spin to be jumped via a shared portion between the processes over which the constraint extends, and it is possible to suppress communication between the processes and shorten a solution search time.

At least one or more of the above-described functions of the search unit 121 and the setting unit 122 may be executed by an information processing apparatus installed and connected at any place on a network, that is, may be executed on so-called cloud computing.

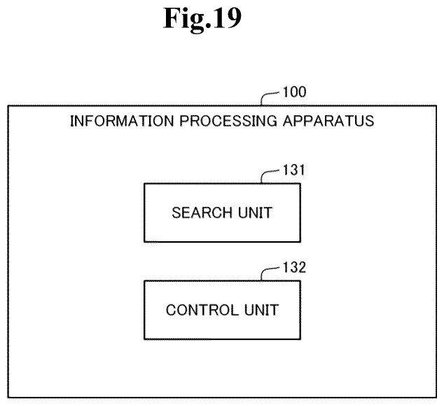

As another example, a search unit 131 and a control unit 132 illustrated in FIG. 19 can be constructed and equipped in the information processing apparatus 100 in the present example embodiment by the CPU 101 acquiring and executing the programs 104. The programs 104 are stored in, for example, the storage device 105 or the ROM 102 in advance, and the CPU 101 loads and executes the programs 104 on the RAM 103, as necessary. The programs 104 may be supplied to the CPU 101 via the communication network 111, or the programs 104 may be stored in the storage medium 110 in advance and the drive device 106 may read the programs 104 and supply the read programs 104 to the CPU 101. However, the above-described search unit 131 and control unit 132 may be constructed by a dedicated electronic circuit for achieving the means.

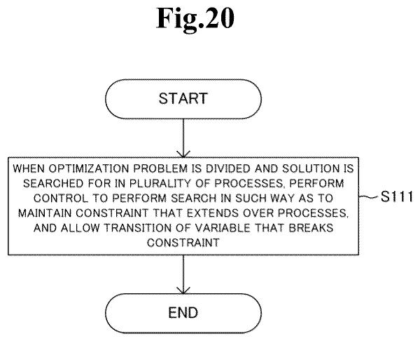

When searching for a solution of a variable of a constrained combinatorial optimization problem in a plurality of processes to which pieces of the optimization problem obtained by dividing the optimization problem are allocated, the above search unit 131 transitions the variable while maintaining a constraint of the variable of the optimization problem that extends over the plurality of processes, and performs the search. The above control unit 132 then performs control to allow transition of the variable that breaks the constraint under a preset condition in addition to the transition of the variable that maintains the constraint (step S111 in FIG. 20).

In the above configuration, the information processing apparatus 100 divides the constrained combinatorial optimization problem and allocates the pieces of the optimization problem obtained by dividing the optimization problem to the plurality of processes, and when searching for the solution in the plurality of processes, normally transitions the variable while maintaining the constraint that extends over the plurality of processes. In addition, the information processing apparatus 100 performs control to allow the transition of the variable that breaks the constraint according to conditions such as a probability based on a temperature parameter used for simulated annealing and the number of times of the transition of the variable that maintains the constraint. As a result, it is possible to cause a spin to be jumped between the processes through a state where the constraint is broken, and it is possible to suppress communication between the processes, and it is possible to shorten a solution search time.

At least one or more of the above-described functions of the search unit 131 and the control unit 132 may be executed by an information processing apparatus installed and connected at any place on a network, that is, may be executed on so-called cloud computing.

The above-described programs can be stored using various types of non-transitory computer readable media and supplied to a computer. The non-transitory computer readable media include various types of tangible storage media. Examples of the non-transitory computer readable medium include a magnetic recording medium (for example, a flexible disk, a magnetic tape, or a hard disk drive), an optical magnetic recording medium (for example, a magneto-optical disc), a compact disc-read only memory (CD-ROM), a CD-R, a CD-R/W, and a semiconductor memory (for example, a mask ROM, a programmable ROM (PROM), an erasable PROM (EPROM), a flash ROM, or a random access memory (RAM)). The programs may also be supplied to the computer by various types of transitory computer readable media. Examples of the transitory computer readable media include electrical signals, optical signals, and electromagnetic waves. The transitory computer readable media can supply the programs to the computer via a wired communication path such as an electric wire and an optical fiber, or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

### SUPPLEMENTARY NOTE

Some or all of the above example embodiments may also be described as in the following Supplementary Notes. Hereinafter, an outline of configurations of the information processing apparatus, the information processing method, and the program in the present disclosure will be described. However, the present disclosure is not limited to the configurations described in the following Supplementary Notes.

Some or all of the configurations described in Supplementary Notes A2 to A8.1 dependent on Supplementary Note A1 described below and the functions according to those configurations can also be dependent on the other Supplementary Notes A9 and A10 by a dependency relationship similar to that of Supplementary Notes A2 to A8.1. Some or all of the configurations described as Supplementary Notes and the functions according to those configurations can be similarly dependent on not only Supplementary Notes A1, A9, and A10, but also various pieces of similar hardware and software, and various types of recording means that record the software, or systems without departing from the above-described example embodiments.

Some or all of the configurations described in Supplementary Notes B2 to B7 dependent on Supplementary Note B1 described below and the functions according to those configurations can also be dependent on the other Supplementary Notes B8 and B9 by a dependency relationship similar to that of Supplementary Notes B2 to B7. Some or all of the configurations described as Supplementary Notes and the functions according to those configurations can be similarly dependent on not only Supplementary Notes B1, B8, and B9, but also various pieces of similar hardware and software, and various types of recording means that record the software, or systems without departing from the above-described example embodiments.

Some or all of the configurations described in Supplementary Notes B1 to B9 described below and the functions according to those configurations can also be dependent on each of the other Supplementary Notes A1 to A10.

### Supplementary Note A1

An information processing apparatus including:
a search unit that searches for a solution of a variable of a constrained combinatorial optimization problem by a plurality of processes to which pieces of the optimization problem obtained by dividing the optimization problem are allocated; and a setting unit that sets the variable shared by a plurality of the processes.

### Supplementary Note A2

The information processing apparatus according to Supplementary Note A1, in which
the setting unit sets the variable shared by a plurality of the processes over which a constraint of the variable of the optimization problem extends.

### Supplementary Note A3

The information processing apparatus according to Supplementary Note A1, in which
the setting unit sets the variable shared by a plurality of the processes connected to each other.

### Supplementary Note A4

The information processing apparatus according to Supplementary Note A3, in which
the setting unit sets the variable shared between the processes connected adjacent to each other.

### Supplementary Note A5

The information processing apparatus according to Supplementary Note A1, in which
the setting unit sets a size of the variable shared by a plurality of the processes based on memory sizes included in the processes.

### Supplementary Note A6

The information processing apparatus according to Supplementary Note A1, in which
the setting unit sets, according to a search situation of the solution of the variable by the processes, the variable shared by a plurality of the processes.

### Supplementary Note A7

The information processing apparatus according to Supplementary Note A6, in which
the setting unit sets, according to a change in a value of the variable at the time of searching for the solution of the variable by the processes, the variable shared by a plurality of the processes.

### Supplementary Note A8

The information processing apparatus according to Supplementary Note A1, in which
the setting unit outputs the variable shared by the processes and a set of the processes that share the variable.

### Supplementary Note A8.1

The information processing apparatus according to Supplementary Note A1, in which
the search unit searches for the solution of the variable of the optimization problem by a plurality of the processes in a state where the variable is shared by the plurality of processes.

### Supplementary Note A9

An information processing method by an information processing apparatus, the information processing method including
setting, when a solution of a variable of a constrained combinatorial optimization problem is searched for by a plurality of processes to which pieces of the optimization problem obtained by dividing the optimization problem are allocated, the variable shared by a plurality of the processes.

### Supplementary Note A10

A program for causing an information processing apparatus to execute processing of
setting, when a solution of a variable of a constrained combinatorial optimization problem is searched for by a plurality of processes to which pieces of the optimization problem obtained by dividing the optimization problem are allocated, the variable shared by a plurality of the processes.

### Supplementary Note B1

An information processing apparatus including:
a search unit that transitions, when a solution of a variable of a constrained combinatorial optimization problem is searched for by a plurality of processes to which pieces of the optimization problem obtained by dividing the optimization problem are allocated, the variable while maintaining a constraint of the variable of the optimization problem, the constraint extending over a plurality of the processes, and performs the search; and
a control unit that performs control to allow transition of the variable that breaks the constraint under a preset condition.

### Supplementary Note B2

The information processing apparatus according to Supplementary Note B1, in which
the control unit performs control to allow the transition of the variable that breaks the constraint with a probability based on a preset value of a parameter used at the time of the search.

### Supplementary Note B3

The information processing apparatus according to Supplementary Note B2, in which
the control unit performs control to allow the transition of the variable that breaks the constraint with a probability based on a temperature parameter used when a probability of transition of the variable is determined even in a case where evaluation of the solution of the variable has deteriorated at the time of the search.

### Supplementary Note B4

The information processing apparatus according to Supplementary Note B2, in which
the control unit performs control in such a way that the probability of allowing the transition of the variable that breaks the constraint decreases as the search proceeds.

### Supplementary Note B5

The information processing apparatus according to Supplementary Note B1, in which
the control unit performs control to allow the transition of the variable that breaks the constraint based on the number of times of the transition of the variable performed while maintaining the constraint.

### Supplementary Note B6

The information processing apparatus according to Supplementary Note B5, in which
the control unit performs control to allow the transition of the variable that breaks the constraint every time the number of times of the transition of the variable performed while maintaining the constraint reaches a specified number of times.

### Supplementary Note B7

The information processing apparatus according to Supplementary Note B1, in which
the control unit performs control in such a way that, after the transition of the variable that breaks the constraint is performed, transition of the same variable is not performed.

### Supplementary Note B8

An information processing method by an information processing apparatus, the information processing method including
transitioning, when a solution of a variable of a constrained combinatorial optimization problem is searched for by a plurality of processes to which pieces of the optimization problem obtained by dividing the optimization problem are allocated, the variable in such a way as to maintain a constraint of the optimization problem, the constraint extending over a plurality of the processes, and performing the search, and performing control to allow transition of the variable that breaks the constraint under a preset condition.

### Supplementary Note B9

A program for causing an information processing apparatus to execute processing of
transitioning, when a solution of a variable of a constrained combinatorial optimization problem is searched for by a plurality of processes to which pieces of the optimization problem obtained by dividing the optimization problem are allocated, the variable in such a way as to maintain a constraint of the optimization problem, the constraint extending over a plurality of the processes, and performing the search, and performing control to allow transition of the variable that breaks the constraint under a preset condition.

### REFERENCE SIGNS LIST

11 division unit
12 shared variable setting unit
13 annealing unit
14 control unit
P1 to Pn process
100 information processing apparatus
101 CPU
102 ROM
103 RAM
104 programs
105 storage device
106 drive device
107 communication interface
108 input/output interface
109 bus
110 storage medium
111 communication network
121 search unit
122 setting unit
131 search unit
132 control unit

1. An information processing apparatus comprising:
at least one memory configured to store processing instructions; and
at least one processor configured to execute the processing instructions to:
transition, when a solution of a variable of a constrained combinatorial optimization problem is searched for by a plurality of processes to which pieces of the optimization problem obtained by dividing the optimization problem are allocated, the variable while maintaining a constraint of the variable of the optimization problem, the constraint extending over a plurality of the processes, and perform the search; and
perform control to allow transition of the variable that breaks the constraint under a preset condition.

2. The information processing apparatus according to claim 1, wherein the at least one processor is configured to execute the processing instructions to
perform control to allow the transition of the variable that breaks the constraint with a probability based on a preset value of a parameter used at the time of the search.

3. The information processing apparatus according to claim 2, wherein the at least one processor is configured to execute the processing instructions to
perform control to allow the transition of the variable that breaks the constraint with a probability based on a temperature parameter used when a probability of transition of the variable is determined even in a case where evaluation of the solution of the variable has deteriorated at the time of the search.

4. The information processing apparatus according to claim 2, wherein the at least one processor is configured to execute the processing instructions to
perform control in such a way that the probability of allowing the transition of the variable that breaks the constraint decreases as the search proceeds.

5. The information processing apparatus according to claim 1, wherein the at least one processor is configured to execute the processing instructions to
perform control to allow the transition of the variable that breaks the constraint based on the number of times of the transition of the variable performed while maintaining the constraint.

6. The information processing apparatus according to claim 5, wherein the at least one processor is configured to execute the processing instructions to
perform control to allow the transition of the variable that breaks the constraint every time the number of times of the transition of the variable performed while maintaining the constraint reaches a specified number of times.

7. The information processing apparatus according to claim 1, wherein the at least one processor is configured to execute the processing instructions to
perform control in such a way that, after the transition of the variable that breaks the constraint is performed, transition of the same variable is not performed.

8. An information processing method by an information processing apparatus, the information processing method comprising:
transitioning, when a solution of a variable of a constrained combinatorial optimization problem is searched for by a plurality of processes to which pieces of the optimization problem obtained by dividing the optimization problem are allocated, the variable in such a way as to maintain a constraint of the optimization problem, the constraint extending over a plurality of the processes, and performing the search, and performing control to allow transition of the variable that breaks the constraint under a preset condition.

9. The information processing method according to claim 8, further comprising
performing control to allow the transition of the variable that breaks the constraint with a probability based on a preset value of a parameter used at the time of the search.

10. The information processing method according to claim 9, further comprising
performing control to allow the transition of the variable that breaks the constraint with a probability based on a temperature parameter used when a probability of transition of the variable is determined even in a case where evaluation of the solution of the variable has deteriorated at the time of the search.

11. The information processing method according to claim 9, further comprising
performing control in such a way that the probability of allowing the transition of the variable that breaks the constraint decreases as the search proceeds.

12. The information processing method according to claim 8, further comprising
performing control to allow the transition of the variable that breaks the constraint based on the number of times of the transition of the variable performed while maintaining the constraint.

13. The information processing method according to claim 12, further comprising
performing control to allow the transition of the variable that breaks the constraint every time the number of times of the transition of the variable performed while maintaining the constraint reaches a specified number of times.

14. The information processing method according to claim 8, further comprising
performing control in such a way that, after the transition of the variable that breaks the constraint is performed, transition of the same variable is not performed.

15. A non-transitory computer-readable storage medium storing a program for causing an information processing apparatus to execute processing of
transitioning, when a solution of a variable of a constrained combinatorial optimization problem is searched for by a plurality of processes to which pieces of the optimization problem obtained by dividing the optimization problem are allocated, the variable in such a way as to maintain a constraint of the optimization problem, the constraint extending over a plurality of the processes, and performing the search, and performing control to allow transition of the variable that breaks the constraint under a preset condition.
